(19) United States
(12) Patent Application Publication
(10) Pub. No.: US 2015/0317732 A1
(43) Pub. Date: Nov. 5, 2015

(54) System and Method of Securities Trading Using a First Sight Multiple Node Network along a Communications Link

(71) Applicant: Edgar Parker, JR., Bayside, NY (US)

(72) Inventor: Edgar Parker, JR., Bayside, NY (US)

(21) Appl. No.: 14/267,905

(22) Filed: May 1, 2014

(51) Int. Cl. G06Q 40/04; H04L 29/08; G06F 17/30

(52) U.S. Cl. CPC G06Q 40/04; H04L 67/10; G06F 17/30864

(57) ABSTRACT

A system comprising a group of linked servers and processors along a communication link configured to allow the first server(s) and/or processor(s) that witness a predetermined trading trigger or satisfied trading condition to communicate this information to the ends of the communication link. The server(s) and/or processor(s) which first witness the trading trigger may be configured to send information about the trading trigger or satisfied trading condition to the other server(s) and/or processor(s) in the network, and additional third parties. The other servers and processors at other locations in the communication network may be utilized to support more complex detection and communication strategies. The two endpoint servers at opposite ends of the network individually and independently examine the trading trigger and the security prices at the particular market closest to the endpoint servers. The two endpoint servers individually and independently decide based on this analysis whether to send a trade order to the market closest to the endpoint server. Additionally the system of linked servers and processors may operate on more than one communications link.

### RELATED APPLICATIONS

The present application claims the benefit under 35 U.S.C. .sctn.119(e) of U.S. Provisional Application Ser. No. 61/818,897, filed May 2, 2013, entitled “ System and Method of Securities Trading Using a First Sight Multiple Node Network along a Communications Link,” which is incorporated herein by reference in its entirety.

### SPECIFICATION

A system comprising a group of linked servers and processors along a communication link configured to allow the first server(s) and/or processor(s) that witness a predetermined trading trigger or satisfied trading condition to communicate this information to the ends of the communication link. The server(s) and/or processor(s) which first witness the trading trigger may be configured to send information about the trading trigger or satisfied trading condition to the other server(s) and/or processor(s) in the network, and additional third parties. The other servers and processors at other locations in the communication network may be utilized to support more complex detection and communication strategies. The two endpoint servers at opposite ends of the network individually and independently examine the trading trigger and the security prices at the particular market closest to the endpoint servers. The two endpoint servers individually and independently decide based on this analysis whether to send a trade order to the

Currently there is trend among companies involved in the trading of securities to locate as close as possible to a trading center or market. This strategy makes sense if most or all of the trading opportunity is based on the relative movement in price of the security at that closest trading center. However there are a great number of trading opportunities that exist between trading markets created by the collective relative movements of prices at those geographically separated markets.

A simple arbitrage example will serve to elucidate the concept of an intermediate trading position and its optimality when compared to a collocated site near a market. A potential arbitrage trading event is created when the prices of the same security differs at two markets. A profit can be generated if one could buy the security at the lower price and sell at the higher price. Along a communication link such as a fiber optic cable between two markets price information travels in opposite directions from and to each market at the endpoints. Price information traveling in opposite directions could be monitored at multiple intermediated points along the communication link. When the prices have a large enough separation an arbitrage opportunity exists. Significantly this arbitrage opportunity will first be known at the place where prices of adequate separation meet. At no other place on earth, including collocated traders at the ends of the communication link, is this trading opportunity known (Unless of course the prices of adequate separation first meet at the collocated point).

Along the communication link detectors or price comparison nodes could be located at regular intervals. As price information travels from geographically separated trading centers at least one of these nodes would be at or nearest to a hypothetical trading event recognition point. Further the node or nodes (if an event falls between two adjacent nodes) may be constructed to be able to transmit the information about recognition of the trading event to both ends of the communication network. From there this information could be utilized to execute coordinated trades at each trading center. Any intermediate node would be able to communicate more quickly the information of a trading event more quickly to both markets than collocated traders at the endpoints.

The method described in this work is based on the assumption that the optimal location from which to conduct a trade is given by the first node or nodes in a network of nodes which recognize that a predetermined trading trigger or trading condition has been satisfied (The term “node(s)” will be used interchangeably with “server(s) and/or processor(s)”).

Each node is composed of at least a server and processor. Instead of attempting to compute the optimal location for positioning a server between trading centers, a multitude of linked servers and processors instead check to see if a trading trigger or threshold has been met. If the trading trigger or threshold has been met the first intermediate node or nodes that recognized the trade sends a signal of the trading opportunity to the two opposite endpoint nodes. The endpoint nodes each independently compare the intermediate node's trading trigger against the security prices from the market closest to each endpoint node. Each endpoint node then decides independently whether to execute a trade in the closest market to that endpoint mode.

Since the intermediate nodes are the first to identify the trading opportunity, they are also the first to be able to act upon that information and propagate that information towards the separated markets. Additionally the amount of time needed to send the trading information back to both of the trading centers will be lower when initiated at one of the intermediate nodes than at a typically collocated point at one of the trading centers.

The communication network could take many forms. The specific method or form of communication that the network or networks use does not change the logic of trading method presented in this work. These various forms include but are not limited to a fiber optic cable network, a microwave relay network, a laser network, and relay or other types of networks based on other electromagnetic wavelengths, a mixture of various network types, or servers and processors linked by any other means that allows communication between the elements of the network and trading centers.

The intermediate node or nodes could communicate by microwave or other wavelengths antennas, satellites, UAV drone relay link, intermediate point or relay point on a fiber optic cable, or linked servers on a distributed network. Miniaturized or even nanoscale servers and processors could be embedded directly in the communications link. Such embedding could occur at many points in the structure of the communication link such as in a fiber optic or wire network.

Other researchers have developed methods of optimally placing an intermediate trading node or server at a point between trading centers based on the characteristics of the communication network and the securities being traded (Wissner-Gross and Freer 2010). The optimal location or server is computed using this information. Trading signals are received from and sent to each trading center from this optimal location.

However, this method may be impractical or its results unstable. Characteristics of the communication network or link between the trading centers may change over time. Additionally the relevant characteristics of the traded securities can also change. These changes can occur rapidly and constantly thus continuously alter the optimal trading location. One would need to constantly update the trading location to trade from the hypothesized optimal position using these methods of the prior art.

Also as the characteristics of both the communication link and the traded securities evolve over time the optimal trading point will actually move. Depending on the particular communication link and the securities involved this change in position could be dramatic and happen over short time scales. This movement in optimal position will mean that many optimal trading opportunities will be potentially missed as new optimal trading locations replace the past optimal locations. Additionally it may necessitate the costly and or impractical physical movement of the trading center to newly computed optimal points. Finally the true “optimality” of the trading center using a (Wissner-Gross and Freer 2010) type method will depend on the accuracy of the model and computations used.

In contrast the “first sight” method relies upon the simplifying assumption that a true optimal site from among many in along a communication link is the first site or sites that witness the trading event. This method in essence allows nature to truly decide the optimal point (or closest or most optimal node or nodes among many). Computations, modeling, and the potential errors of other methods such as (Wissner-Gross and Freer 2010) are not necessary and neither is the potentially costly movement to a newly computed optimal location from a previously computed optimal location.

Only the first node that witnesses the trading event responds by sending trading instructions to the two trading centers. The other nodes may receive a signal from the trade executing node informing of the trade. This signal may cause these other nodes to refrain from executing a trade on the same, but delayed information.

The above logic can be extended to a plurality of trading nodes and to a plurality of trading centers in more than 1 dimension. The servers and/or processors can be thought of occupying a two dimensional (or higher) grid with servers and/or processors at a plurality of points. The grid of servers and/or processors will surround a group of different markets. The servers and/or processors to first witness a trading trigger or satisfied trading condition may be configured to send trading instructions to several endpoint servers which then decide whether to trade based on the prices at the market closest to the endpoint server.

Individual independent trading centers or companies at different locations along a communications network or networks may decide to cooperate to form a multiple node network. The independent trading nodes would mimic the new trading behavior of a multiple first site trading network as described in this paper. Specifically the independent traders would agree to use the first nodes that witness the trades to execute the trades and further coordinate using the methods described in the present disclosure. Additionally the independent traders would further agree to an equitable split of the trading profits achieved by the arrangement.

### BACKGROUND ART

Parker, Edgar, “Efficient Markets Meet the Shannon Limit (New Perspectives at the Intersection of Finance, Physics, and Information Theory)”, Amazon Kindle Direct Publishing (KDP), 2^{nd} Edition 2014., provides a discussion of the theory behind the present invention.

### REFERENCE

Wissner-Gross, Alexander and Cameron Freer. 2010. “Relativistic Statistical Arbitrage”. Physical Review E 82(5): 056104-056110.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an exemplary operating environment for a system in accordance with some embodiments of the present disclosure.

FIGS. 2a and 2b are block diagrams illustrating a trading center and a server in accordance with some embodiments of the present disclosure.

FIG. 3 is an illustrative diagram of an exemplary collocated distributed financial transaction executed using methods known in the prior art.

FIG. 4 is an illustrative diagram of an exemplary intermediate node distributed financial transaction executed using methods known in the prior art.

FIG. 5 is an illustrative diagram of an exemplary first sight multiple node distributed financial transaction executed in accordance with some embodiments of the present disclosure.

FIG. 6 is a flowchart of an illustrative process for executing a first sight multiple node distributed financial transaction executed in accordance with some embodiments of the present disclosure.

FIG. 7 is a block diagram generally illustrating an example of a computer system that may be used in implementing aspects of the present disclosure.

### DETAILED DESCRIPTION OF THE EXEMPLARY EMBODIMENTS

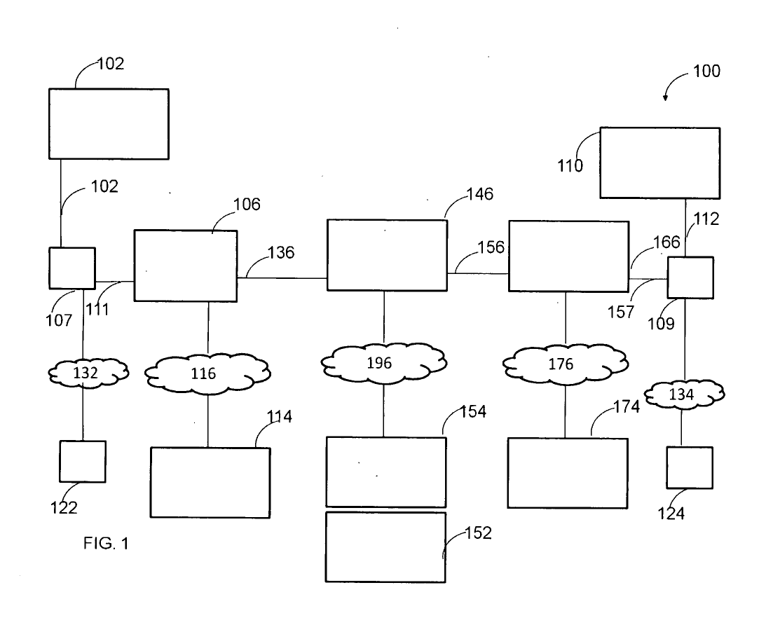

A block diagram of an illustrative system 100 comprising intermediate servers 106, 146, and 166 for detecting the existence of a trading condition is shown in FIG. 1 The number of servers illustrated is limited to three only for ease of presentation and clarity, however more generally many more servers and computers can be added creating more similar trading platforms along the communications link.

Servers 106, 146, and 166 may be configured to detect the existence of a trading condition by analyzing pricing information from trading centers 102 and 110. Servers 106, 146, and 166 may be individually be configured to also send information about the detection a trading condition to the endpoint servers 107 and 109 through networks 111, 136, 156, and 157. Additional intermediate servers similar to 106, 146, and 166 can be added to the network between the endpoint servers 107 and 109. Additionally computers similar to 114, 154, and 174 can be added to the network between the trading centers.

Human user 152 may configure the servers 106, 146, 166, 107, and 109 by using computers 114, 154, 174, 122, and 124 via network 132, 134, 116, 196, or 176 which may comprise, for example, the Internet, a LAN, a WAN and/or any other wired or wireless network, or combination thereof.

The servers 106, 107, 109, 146, and 166 may individually be configured to receive information about securities, including but not limited to equities, derivatives, fixed-income products, and currencies. Trade instructions sent to trading centers 102 and 110 from servers 107 and 109 may specify any of numerous trading strategies. For example, the instructions may satisfy an arbitrage or statistical arbitrage, or pairs trade.

Communication links 111, 157, 136, and, 156 may transmit information using electromagnetic waves of any suitable frequency including frequencies in the radio, microwave, visible, infrared, and ultra-violet ranges of the electromagnetic spectrum. Additionally the communication links 111, 157, 136, and, 156 may be composed of but not limited to any technology for transmitting information including satellites, transmitters, receivers, antennas, repeaters, and/or radios. The above system may be implemented in many ways including using more than two trading centers and utilizing as many servers and computers between the trading centers as desired.

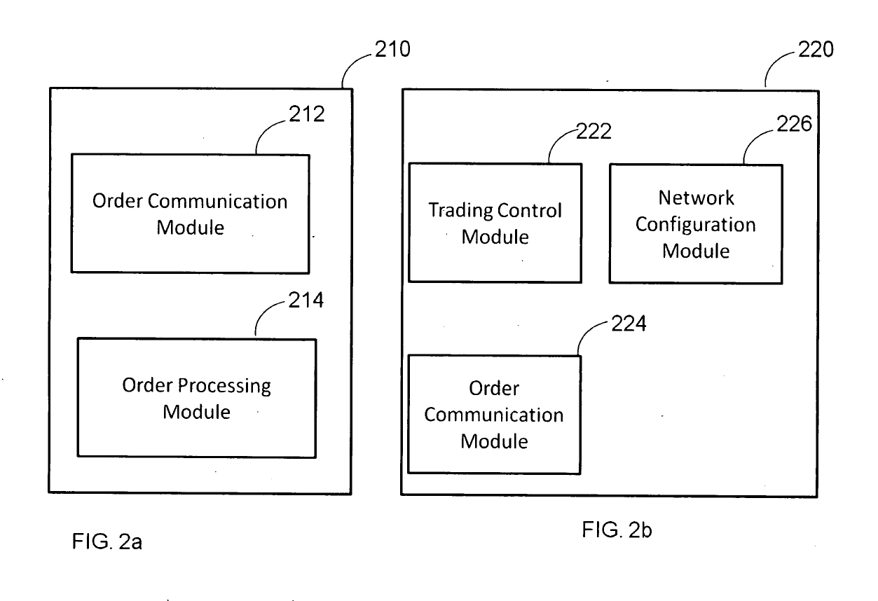

FIGS. 2a and 2b show illustrative block diagrams of software components that may execute at a trading center such as 102 and server 106 to perform or help perform functions described with reference to FIG. 1. FIG. 2a shows an illustrative block diagram of software components of an electronic trading center 210. These software components may be stored as computer-executable instructions and configuration parameters in a memory linked to trading center 210. Components in module 212 may have functions related to sending and receiving trade instructions to buy or sell a financial instrument. Components in module 214 may have functions related to executing orders received by module 212.

FIG. 2b shows a representation of an illustrative block diagram of software components that may execute within server 220. Module 222 may determine the time and type of trade to make, and which financial instruments to trade. Additionally module 222 may specify trade instructions including but not limited to the amount of the trade, and whether trade conditions have been met or satisfied.

Module 226 may be used to configure server 220 to communicate with one or more trading centers and/or one or more of the other intermediate node servers.

Module 224 may be used to configure server 220 to perform functions related to sending trade instructions to one or more trading centers and may also receive a response to trade instructions indicating for example whether a trade has taken place. Module 224 may also be used to configure server 220 to perform functions related to sending trade instructions to one or more of the other intermediate node servers.

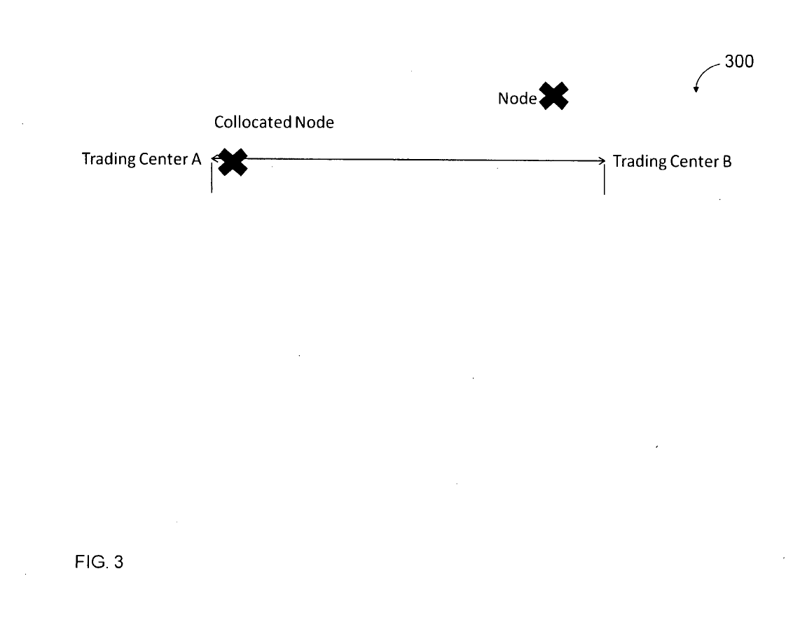

FIG. 3 is an illustrative diagram of process 300 which is an exemplary collocated distributed financial transaction executed using methods known in the prior art. The total information travel time is 2a, where a is the information travel time in one direction from A to B.

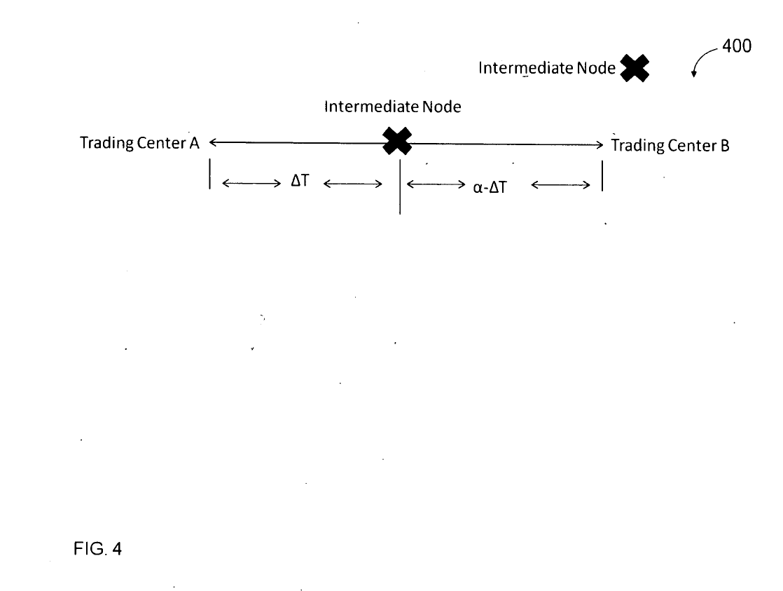

FIG. 4 is an illustrative diagram of process 400 which is an exemplary intermediate node distributed financial transaction executed using methods known in the prior art. Total information travel time=max[2ΔT, 2(α−ΔT)]. If ΔT=α/2, the intermediate node is exactly halfway, and information transit time is α. This is half the time taken in FIG. 4

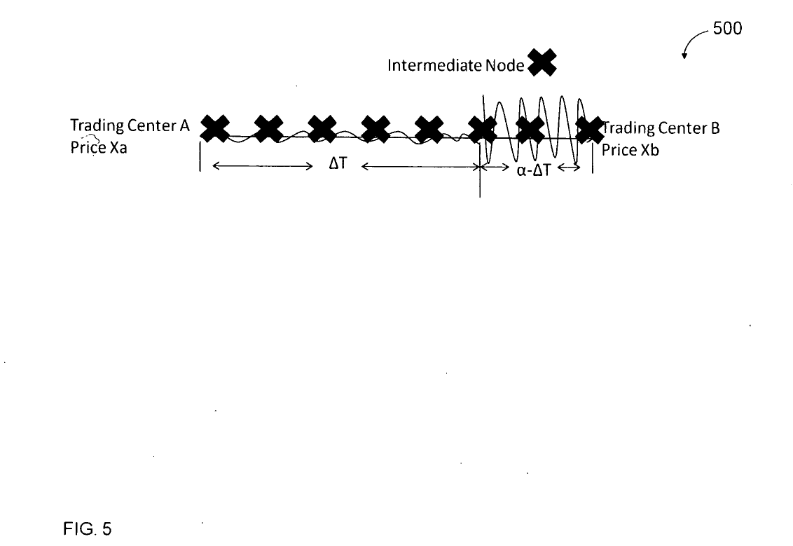

FIG. 5 is an illustrative diagram of process 500 which is an exemplary first sight multiple node distributed financial transaction executed in accordance with some embodiments of the present disclosure. Total time=max[2ΔT, 2(α−ΔT)]. If ΔT=α/2, the intermediate node is exactly halfway, and information transit time is α.

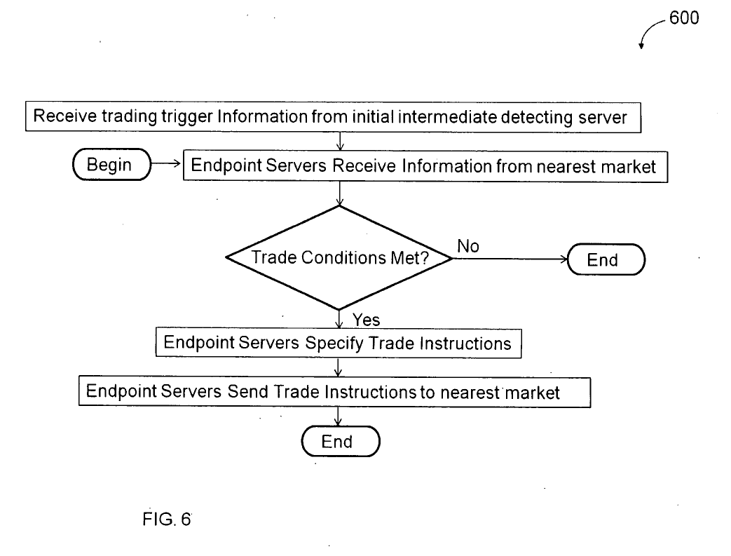

FIG. 6 is a flowchart of an illustrative process 600 for executing a first sight multiple node distributed financial transaction executed in accordance with some embodiments of the present disclosure. The intermediate servers are the servers such as 106, 146, and 166 in FIG. 1. The endpoint servers are the servers such as 107 and 109 in FIG. 1. The trading centers A and B are examples of 102 and 110 of FIG. 1.

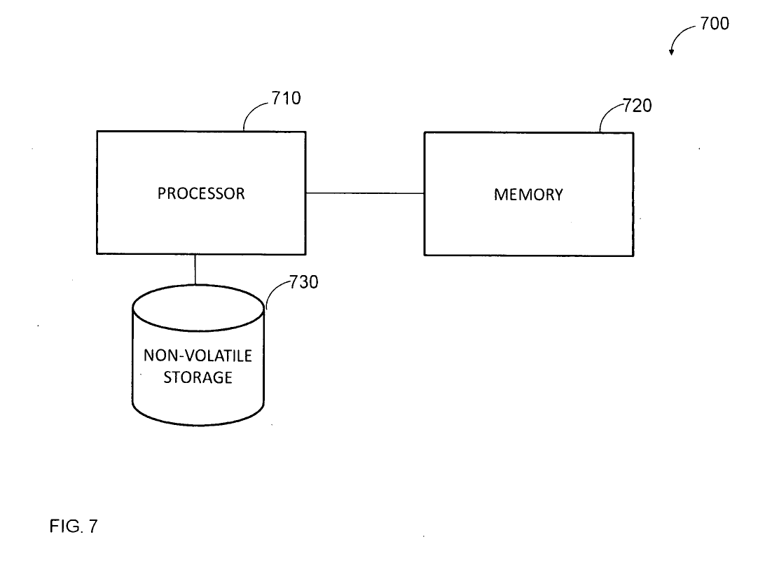

FIG. 7 is a block diagram generally illustrating an example of a computer system that may be used in implementing aspects of the present disclosure. The computer system may have one or more processors 710, one or more non-transitory computer storage media 720 or memory, and one or more non-volatile storage media 730. The processor 710 may execute one or more instructions stored in one or more computer-readable storage media (or memory 720).

1. A system comprising a programmed group of linked servers and processors along a communication link configured to allow the first server and/or processor that witness a predetermined trading trigger or satisfied trading condition to communicate that information through nearby servers and processors all the way to the opposite ends of the communication link.

2. The system of claim 1 wherein, the final two servers and processors at opposite ends of the communication network may be configured to individually and independently compare the initial server and or processor trading trigger information against current prices at the market closest to the individual final node to determine if a trading condition still exists.

3. The system of claim 1 wherein, the final two nodes at opposite ends of the communication network may be configured to individually and independently send the buy and or sell order or orders based on analysis of claim 2 to the market closest to the individual final node.
